(19) United States
(12) Patent Application Publication
(10) Pub. No.: US 2009/0245102 A1
(43) Pub. Date: Oct. 1, 2009

(54) NETWORK BACKUP SYSTEM AND METHOD

(75) Inventor: Jen-Chieh Feng, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: CHUNGHWA TELECOM CO., LTD., Taipei (TW)

(21) Appl. No.: 12/328,335

(22) Filed: Dec. 4, 2008

(30) Foreign Application Priority Data
Mar. 28, 2008 (TW) 097111223

(51) Int. Cl. H04L 12/24

(52) U.S. Cl. 370/228

(57) ABSTRACT

A network backup system and method are proposed. The network backup system provides a function for automatically switching network connection lines when a network connection line fails to provide a normal connection, thereby allowing a user to keep processing data transmission via a network system, without any interruption, and data transmission efficiency of the network system to be effectively enhanced.

### BACKGROUND OF THE INVENTION

1. Field of the Invention

This invention generally relates to a network backup system and method, and more specifically, to a network backup system and method related to switching network connection lines of network system.

2. Description of Related Art

Network usage is getting more and more popular since humans' history turns to the 21^{st} century, and interaction between networks and humans has become a matter that can no longer be overlooked. In the past, humans received information mostly from newspapers, magazines, broadcasts, movies, and TVs, but nowadays, most information received comes from networks; what networks bring to our daily life has become mainstream of modern cultures affecting our daily life, thought, and fashion trends.

While vigorously flourishing, the networks have become the most economic communication transmission media that cover the widest scope of information, since humans are getting more and more relying on the networks in daily life, network quality is meanwhile becoming more and more important to every user.

Network bandwidth is generally used as a major factor for deciding the quality of a network; briefly, bandwidth is the Internet access speed, unit of the transmission speed is bps, bits per second. When the bandwidth is larger, it means that more bits are to be transmitted per second, also means enabling user to transmit more data in a fixed time. Network bandwidth is particularly important for a network system that provides instant audio/video services, to prevent the instant audio/video services from delaying or losing reality, transmission speed of the network system must be fast enough.

In addition to the network bandwidth, hardware/software equipment of network connection also plays an important role in deciding network quality; to avoid interruption of network access caused by network failure, how to properly use a backup device to maintain network quality is as important as increasing network bandwidth. Accordingly, a prior technique is provided, wherein a plurality of network connection line modules are simultaneously connected to a network system, therefore when one of the connection line modules fails, user is able to manually switch connection to another network connection line module, the interrupted connection is thus resumed.

Although the backup devices of the abovementioned prior art allows the user to resume the interrupted connection, followed are some drawbacks, which need to be improved.

The first drawback is wasting time. When a connection line fails, management has to find out the problem manually, also when a backup network connection line is available, and then manually switching connection to other network connection line module of backup network connection line and changing connection setup. And if the user is not familiar with procedures of switching power lines and changing setup, a new connection cannot be built. Even in a situation that the user is familiar with the procedures, it takes time to complete a manual reconnection process, it is wholly inconvenient and wasting time.

The second drawback is data transmission being interrupted. During the switching and setup process of backup device, the network connection is being interrupted. The user has to wait until the switching and setup process of the backup device is completed to resume data transmission. Therefore, if the network system is providing an instant audio/video service at that moment, or is transmitting important data, surely causing the user a great disadvantage.

In view of the above, it is a highly urgent issue in the industry for how to provide an efficient backup system and method, which are capable of solving the drawbacks of the prior arts as mentioned above.

### SUMMARY OF THE INVENTION

In view of the disadvantages of the prior art mentioned above, a network backup system is provided according to the present invention, which is applicable to computer device, the computer device is connected to network system via a primary connection line and at least a backup network connection line, the network backup system comprises: a setup module, which is for switching the primary and/or backup network connection lines based on preset network connection line setup specification; and a detection module, which is for detecting if a connection status between the computer device and the primary and/or the backup network connection lines is normal or not, and when an abnormal connection status between the computer device and the primary and/or backup network connection line is detected, commanding the setup module to switch connections between the computer device and the primary and/or backup network connection lines based on the preset network connection lines setup specification.

In another mode of the present invention, further comprising a plurality of computer devices, these computer devices are connected to the primary and/or backup network connection lines via a first network system. The first network system can be, e.g. a local area network system, also the first network system can be, e.g. wired and/or wireless network system.

In a further mode of the present invention, comprising a plurality of backup network connection lines, also the setup module is for switching the primary and/or the backup network connection lines orderly, based on preset backup network connection line specification.

In still another mode of the present invention, comprising a plurality of router devices separately connecting to corresponding said primary network connection line and said backup network connection line, the router device can be, e.g. a modem, also one end of the router device opposite to the end connecting to the computer device is for connecting to a second network system. Beside, the second network system can be a wide area network system, and the second network system can be, e.g. wired and/or wireless network system.

In still another mode of the present invention, further comprising a recording module, which is for recording operation flows of the setup module and the detection module.

A network backup method is further provided according to the present invention, the network backup is applicable to computer device, and the computer device is connected to network system via a primary network connection line and at least a backup network connection line, the network backup method comprises: (1) initializing the computer device, thereby enabling the computer device to connect to the network system via the primary network connection line; and (2) detecting if the primary network connection line is operating normally, if yes, then keeping the connection between the computer device and the network system via the primary network connection line, otherwise, commanding the computer device to switch connection to the backup network connection line, thereby keeping connection between the computer device and the network system via the backup network connection line.

In another mode of network backup method of the present invention, further comprising (3) when the computer device switches connection to the backup network connection line, keeping detecting if the primary network connection line is operating normally, if yes, then commanding the computer device to switch the connection back to the primary network connection line, thereby enabling the computer device to connect to the network system via the primary network connection line.

In a further mode of network backup method of the present invention, further comprising a plurality of computer devices, these computer devices are connected to the primary and/or the backup network connection lines via a first network system. The first network system can be, e.g. a local area network system, also the first network system can be, e.g. wire and/or wireless network system; and in the step (2), further comprising switching the primary and/or backup network connection lines orderly based on preset backup network connection line setup specification.

In still another mode of network backup method of the present invention, the computer devices are separately connected to corresponding said primary network connection line and said backup network connection lines via a plurality of router devices, the router devices can be, e.g. modems, also one side of the router device opposite to the side connecting to the computer device is for connecting to a second network system. Beside, the second network system can be, e.g. a wide area network system, also the second network system can be, e.g. wired and/or wireless network system.

In still another mode of network backup method of the present invention, further comprising (4) recording operation flow of the network backup method.

Compared with the prior art, the network backup system and method of the present invention are characterized by providing the computer device with a detection module to detect if network connection is normal or not, also automatically switching network connection lines for resuming connection to another network connection line by a setup module if an abnormal connection is being detected. Thereby providing user with timely network backup service, also keeping application programs in operation from interruption.

Hence, the network backup system and method provided by the present invention are capable of effectively increasing data transmission efficiency of network system, not only avoiding wasting time, but also preventing important data from being lost during a transmission process.

### BRIEF DESCRIPTION OF DRAWINGS

The present invention can be more fully understood by reading the following detailed description of the preferred embodiments, with reference made to the accompanying drawings, wherein:

FIG. 1a is an application architecture diagram of a first embodiment of network backup system of the present invention;

FIG. 1b is a flowchart of a first embodiment of network backup method of the present invention;

FIG. 2 is an application architecture diagram of a second embodiment of network backup system of the present invention;

FIG. 3a is an application architecture diagram of a third embodiment of network backup system of the present invention;

FIG. 3b is a flowchart of a second embodiment of network backup method of the present invention; and

FIG. 4 is an application architecture diagram of a fourth embodiment of network backup system of the present invention.

### DETAILED DESCRIPTION OF PREFERRED EMBODIMENTS

The following illustrative embodiments are provided to illustrate the disclosure of the present invention; those in the art can apparently understand these and other advantages and effects after reading the disclosure of this specification. The present invention can also be performed or applied by other different embodiments. The details of the specification may be on the basis of different points and applications, and numerous modifications and variations can be devised without departing from the spirit of the present invention.

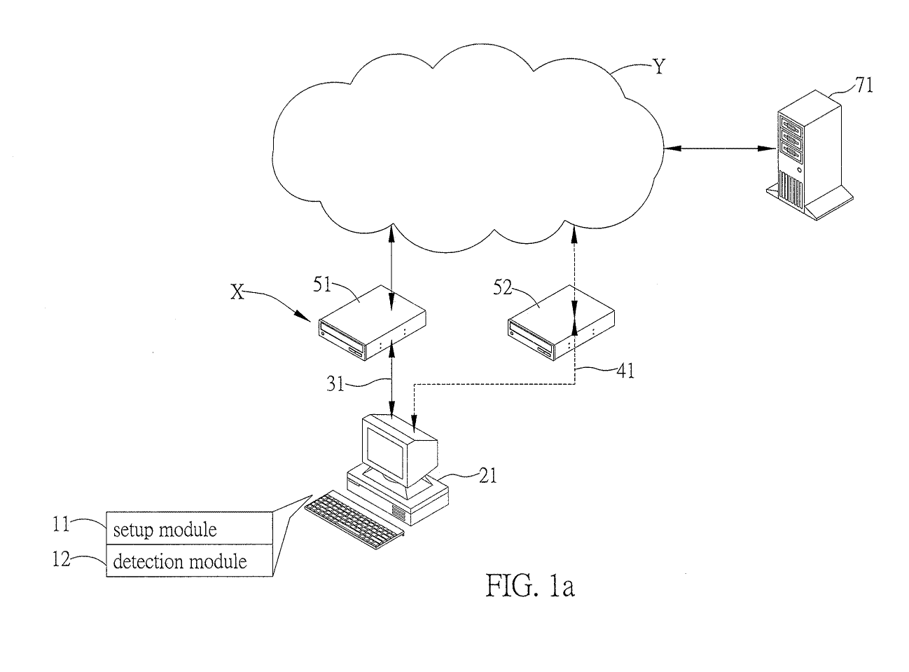

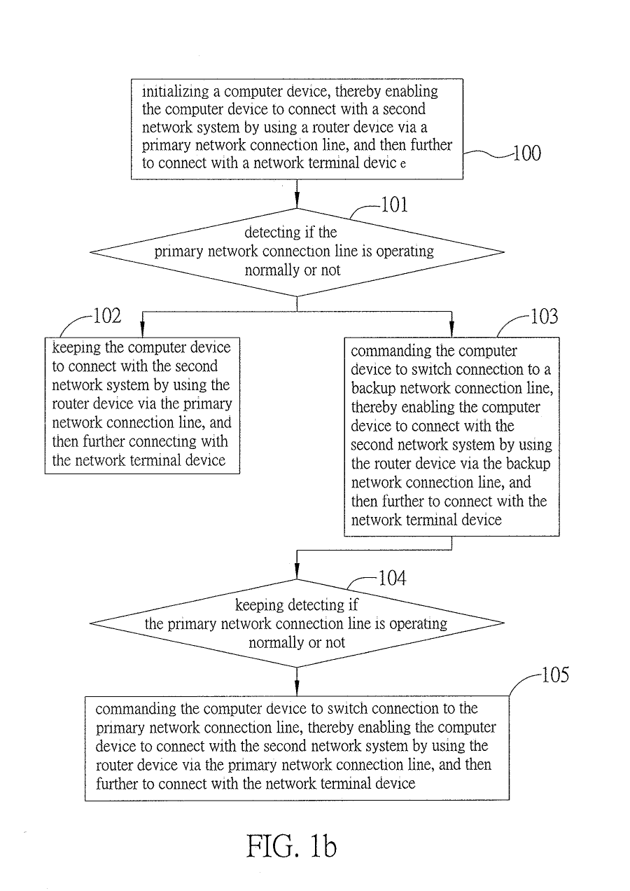

Please refer to FIG. 1a, which is an application architecture diagram of a first embodiment of network backup system of the present invention. As shown in the FIG., the network backup system of the present invention is applicable to computer device 21, the computer device 21 is connected to network system via a primary network connection line 31 and backup network connection line 41. In the present embodiment, the primary network connection line 31 and the backup network connection line 41 can be ADSL, SDSL, HDSL2, and/or G.SHDSL architectures, or FTTB (Fiber To The Building) architecture, but not restricted to as stated herein.

In addition, in the present embodiment, the network backup system of the present invention can selectively comprise a router device 51 and a router device 52 connecting to corresponding said primary network connection line 31 and said backup network connection line 41 respectively. According to the stated aforesaid, the primary network connection line 31 and the backup network connection line 41 are ADSL architectures, therefore the router devices 51 and 51 are ADSL modems (ATUR.)

Furthermore, the computer device 21 is connecting with the router devices 51 and 52 via a first network system X, the first network system X can be, e.g. Internet, intranet, extranet, local area network system (LAN), wide area network system (WAN), or virtual private network system (VPN.) In the present embodiment, a local area network is illustrated as an example of the first network system X, also each of the router devices 51 and 52 has at least a local area network connection port, not shown in the FIG., for being able to connect with the computer device 21 via the first network system X. In addition, the first network system X can be, e.g. wired and/or wireless network system. In the present embodiment, a wired network system is illustrated as an example of the first network system X.

Meanwhile, the router devices 51 and 52 are further connecting to other network terminal device 71, e.g. a commercial application mainframe, via a second network system Y, the second network system Y can be, e.g. Internet, intranet, extranet, local area network (LAN), wide area network (WAN), or virtual private network (VPN.) In the present embodiment, a wide area network is illustrated as an example of the second network system Y, and each of the router devices 51 and 52 has at least a wide area network connection port, not shown in the FIG., thereby allowing the router devices 51 and 52 to connect with the network terminal device 71 via the second network system Y. In addition, the second network system can be, e.g. wired and/or wireless network system. In the present embodiment, a wired network system is illustrated as an example of the second network system Y.

The network backup system of the present invention comprises: a setup module 11 and a detection module 12.

Specifically, the setup module 11 and the detection module 12 of the network backup system of the present invention can be installed in the computer device 21 by means of application programs or agent programs, thereby enabling the computer device 21 to execute network backup operation of the present invention.

The setup module 11 is for switching the primary network connection line 31 and/or the backup network connection line 41 based on preset network connection line setup specification. In the present embodiment, the preset network connection line setup specification can be, for instance, “in an initialization process of computer device 21, when the network backup system of the present invention not yet starts to operate, or when all of the primary network connection line 31 and/or backup network connection line 41, connection mode of the computer device 21 is set up to connect to a local area network connection port of the router device 51 of the primary network connection line 31”; “when the detection module 12 detects that the primary network connection line 31 is operating abnormally, switching connection between the computer device and the primary network connection line 31 to the backup network connection line 41”; and “when the computer device 21 is switched to connect to the backup network connection line 41, keeping detecting if the primary network connection line is back to operate normally, if yes, commanding the computer device 21 to switch connection to the primary network connection line 31.”

The detection module 12 is for detecting if a connection status of the primary network connection line 31 and/or the backup network connection line 41 with the computer device 21 is normal or not, also when an abnormal connection status of the primary network connection line and/or the backup network connection line is detected, commanding the setup module 11 to switch connections between the computer device 21 and the primary network connection line 31 and/or the backup network connection line 41 based on said preset network connection line setup specification.

Meanwhile please refer to FIG. 1b, which is a flowchart of a first embodiment of network backup method of the present invention. As shown in the FIG., in step S100, initializing the computer device 21, thereby enabling the computer device 21 to connect with the second network system Y by using a router device 51 via the primary network connection line 31, and then further to connect to the networking terminal device 71. Next, proceeding to step S101.

In the step S101, detecting if the primary network connection line 31 is operating normally, if yes, then proceeding to step S102; otherwise, proceeding to step S103.

In the step S102, keeping the computer device 21 connect with the second network system Y via the primary network connection line 31 by using the router device 51, thereby further connecting with the network terminal device 71. Next, proceeding back to step S101.

In the step S103, switching the computer device 21 to connect with the backup network connection line 41, thereby enabling the computer device 21 to connect with the second network system Y by using the router device 52 via the backup network connection line 41, and then further to connect with the network terminal device 71. Next, proceeding to step S104.

In the step S104, keeping detecting if the primary network connection line is operating normally, if yes, then proceeding to step S105; otherwise, repeating step S104.

In the step S105, commanding the computer device 21 to switch connection to the primary network connection line 31, thereby enabling the computer device to connect to the second network system Y by using the router device 51 via the primary network connection line 31, and further to connect with the network terminal device 71.

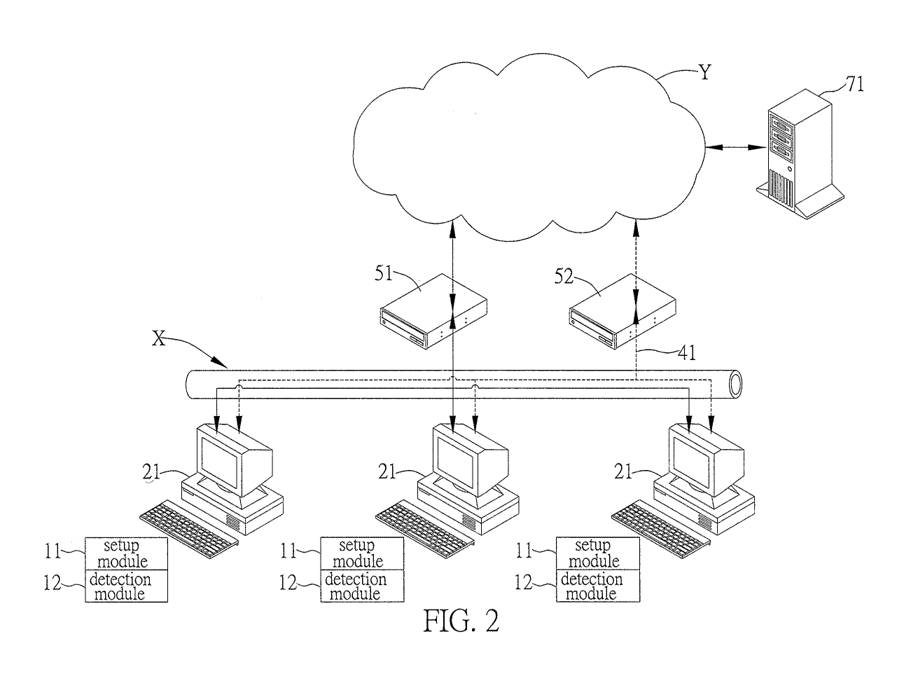

Please refer to FIG. 2, which is an application architecture diagram of a second embodiment of network backup system of the present invention. As shown in the FIG., in the present embodiment, the application architecture of network backup system of the present invention is mostly similar to as shown in the first embodiment, major difference from the first embodiment is that the present embodiment comprises a plurality of computer devices 21, these computer devices are separately connecting to the primary network connection line 31 and/or the backup network connection line 41 via the first network system X. Also each of the plurality of computer devices 21 is individually able to apply said backup network system of the first embodiment to execute setup, detection, and switch processes of the primary network connection line 31 and/or the backup network connection line 41.

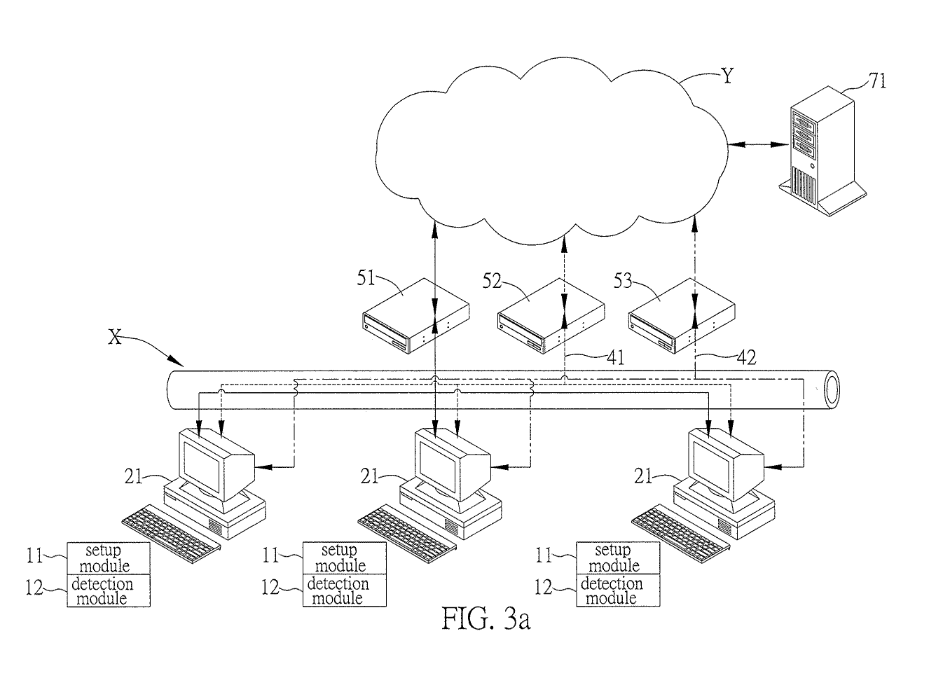

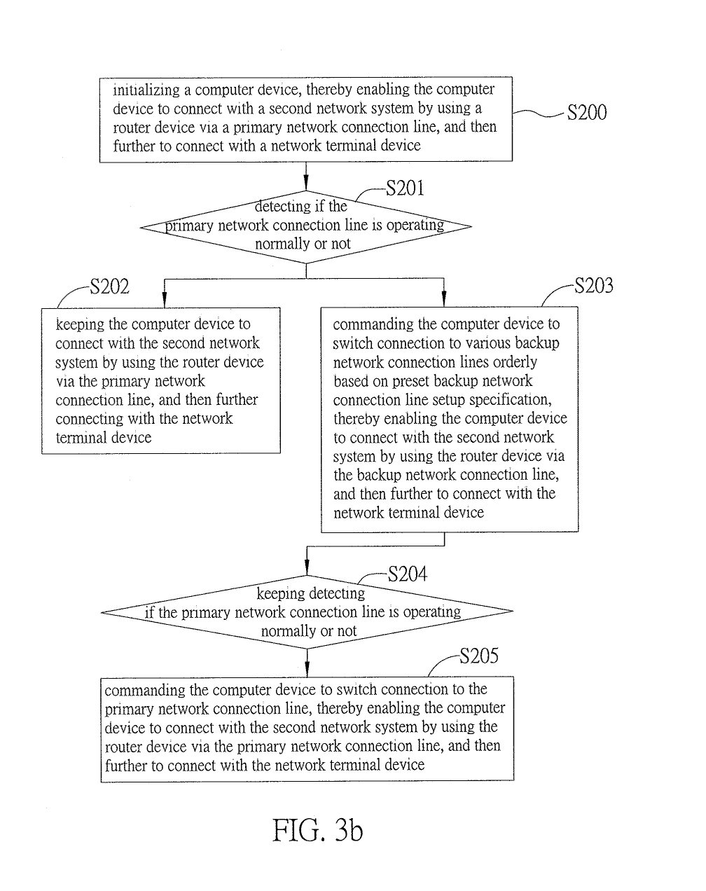

Please refer to FIG. 3a, which is an application architecture diagram of a third embodiment of network backup system of the present invention. As shown in the FIG., in the present embodiment, the application architecture of network backup system of the present invention is mostly similar to as shown in the first and the second embodiments, major difference from the first and the second embodiments is that the present embodiment comprises two backup network connection lines 41 and 42, and two router devices 52 and 53 that are connecting with the backup network connection lines 41 and 42 respectively. Also the setup module 11 switches the primary network connection line 31, the backup network connection line 41, and/or the backup network connection line 42 orderly based on preset backup network connection line setup specification. It has to be stated herein, number of backup network connection line and corresponding router device can be more than two, while in the present embodiment, only two backup network connection lines and two corresponding router devices are illustrated as an example.

The preset backup network connection line setup specification can be, for instance, “when at least the connection status of primary network connection line 31 is normal, or when the connection status of primary network connection line 31 and any other backup network connection line 41 or 42 is normal, keeping default gateway of computer device to the primary network connection line 31 of primary router device 51”; “when backup status of backup network connection line 41 or 42 is not existing, commanding the computer device 42 to switch connection to primary network connection line 31”; “when connection status of primary network connection line is abnormal, but connection status of backup network connection lines 41 and/or 42 is still normal, commanding computer device 21 to switch connection to backup network connection line 41”; “when primary network connection line 31 and backup network connection line 42 are both operating abnormally, but backup network connection line 42 and other backup network connection lines are still normal, commanding computer device 21 to switch connection to backup network connection line 42”; “when primary network connection line 31, backup network connection line 41, and backup network connection line 42 are all operating abnormally, action to be executed is deduced from abovementioned rules”, and/or “based on amount of flow and bandwidth size of the backup network connection lines, switching primary network connection line 31, backup network connection line 41, and backup network connection line 42.”

Meanwhile please refer to FIG. 3b, which is a flowchart of a second embodiment of network backup method of the present invention. As shown in the FIG., in step S200, initializing the computer device 21, thereby enabling the computer device 21 to connect with the second network system Y by using the router device 51 via the primary network connection line 31, and then further to connect with the network terminal device 71. Next, proceeding to step S201.

In the step S201, detecting if the primary network connection line 31 is operating normally, if yes, proceeding to step S202; otherwise, proceeding to step S203.

In the step S202, keeping the computer device 21 connect to the second network system Y by using the router device 51 via the primary network connection line 31, thereby further connecting with the network terminal device 71. Also proceeding back to step S201.

In the step S203, commanding the computer device 21 to switch connection to various backup network connection lines 41 and 42 orderly based on preset backup network connection line setup specification, thereby enabling the computer device 21 to connect to the second network system Y by using the router device 52 or 53 via the backup network connection line 41 or 42, and then further to connect with the network terminal device 71. Next, proceeding to step S204.

In the step S204, keeping detecting if the primary network connection line 31 is operating normally, if yes, then proceeding to step S205; otherwise, repeating step S204.

In the step S205, commanding the computer device 21 to switch connection to the primary network connection line 31, thereby enabling the computer device 21 to connect to the second network system Y by using the router device 51 via the primary network connection line 31, and then further to connect with the network terminal device 71.

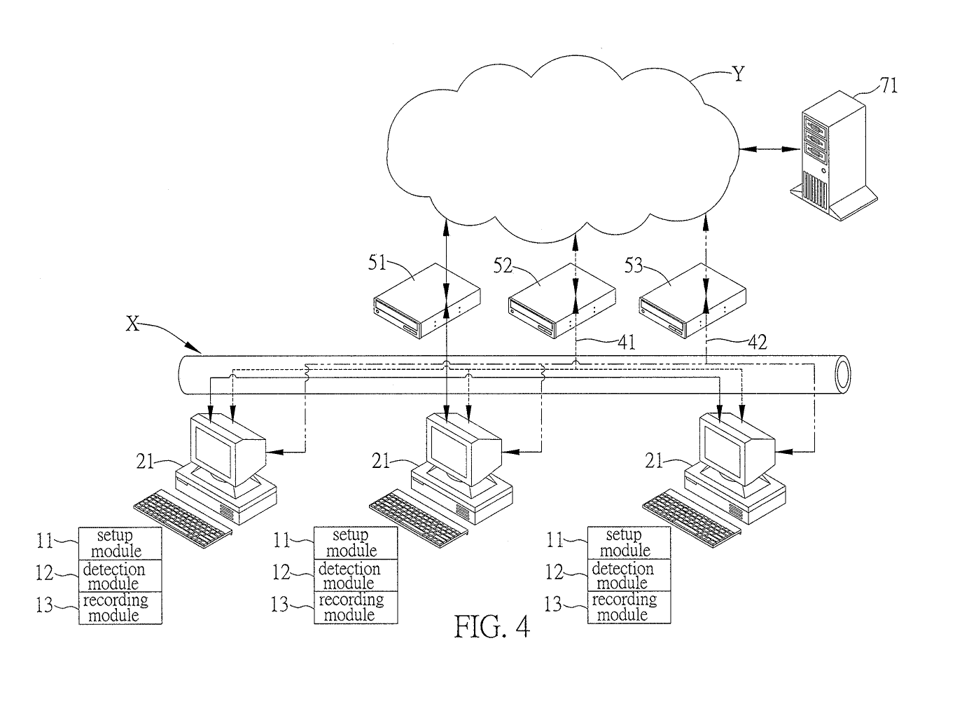

Please refer to FIG. 4, which is an application architecture diagram of a fourth embodiment of network backup system of the present invention. The present embodiment is integrable with said network backup system of the present invention as shown in the first, the second, and the third embodiments; integrating with the third embodiment is illustrated herein as an example of the present embodiment. As shown in the FIG., the network backup system of the present invention further comprises a recording module 13, which is for recording operation flows of the setup module 11 and the detection module 12.

Specifically, when a network connection line is operating abnormally, user is able to keep working through network without interruption by using the network backup system of the present invention, however, without knowing the causes of abnormality of network connection line, maintenance and repair speed of network connection line is slowed down thus. The recording module 13 is for recording operation flow, including connection quality and causes of failure of the network connection line, thereby providing user with maintenance and repair references, and then speeding up maintenance and repair process, further enabling the computer device 21 to quickly switch connection back to the primary network connection line.

Preferably, in the process of executing the second embodiment of the network backup method of the present invention in the network backup system of the present embodiment, further comprising recording each step of operation flow of the network backup method.

In summary, when a primary line is unable to operate normally, by implementing the network backup system and method of the present invention, network connection line will be switched to a backup line. Management is able to repair the primary line without interrupting computer from working through network. Compared with backup line, the primary line is commonly a connection line with larger bandwidth and better quality. Generally speaking, backup line is mostly shared by a group of computers, therefore, when the backup line is activated to serve its purpose, meanwhile keeping detecting if the primary line is back to operate normally, as soon as the primary line is ready to operate normally, instantly switching connection back to the primary line provides a means of enhancing network usage efficiency.

In a more ideal embodiment, step S3′ further comprises comparing amount of flow and/or size of bandwidth of a plurality of backup lines for setting up switch priority of these backup lines.

As stated above, a backup line is mostly shared by a group of computers, and its quality is not as well as the primary line. Also each of the plurality of backup lines provides different network transmission efficiency from one another. For instance, when a backup line I is occupied by a first group of computers, and later if a second group of computers still choose to use the same backup line I as backup line, then overall network transmission efficiency is decreased. Therefore, when a primary line is operating abnormally, first comparing amount of flow and/or size of bandwidth of the plurality of backup lines, and then choosing a line that provides largest flow amount and/or bandwidth from these backup lines to serve as backup network connection line, thereby enhancing network usage efficiency.

In any said embodiment of the present invention, the router device can comprises a plurality of routers; also the network connection line can be Asymmetric Digital Subscriber Line (ADSL). Different network connection line is to connect with different ADSL modem (ATUR). The network backup method can be implemented by network backup software installed in the computer, for instance, making switch on default gateway of the computer for setting up network connection lines used by the computer.

In summary, the network backup system and method of the present invention are capable of enhancing network usage efficiency, not only saving time and manpower during network backup operation, but also avoiding interruption in the process of data transmission, hence the influence of network connection line abnormality on users is dramatically reduced.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A network backup system, which is applicable to a computer device connected to a network system via a primary network connection line and at least a backup network connection line, the network backup system comprising:
a setup module for switching at lease one of the primary network connection line and the backup network connection line based on a preset network connection line setup specification; and
a detection module for detecting whether a connection status between the primary network connection line and/or backup network connection line and the computer device is abnormal, and commanding the setup module to switch connections between the primary network connection line and/or the backup network connection line and the computer device if the connection status between the primary network connection line and/or the backup network connection line and the computer device is detected to be abnormal.

2. The network backup system of claim 1, further comprising a first network system and a plurality of computer devices connected to the primary network connection line and/or the backup network connection line via the first network system.

3. The network backup system of claim 2, wherein the first network system is Internet, intranet, extranet, local area network (LAN), wide area network (WAN), or virtual private network (VPN).

4. The network backup system of claim 2, wherein the first network system is a wired and/or wireless network system.

5. The network backup system of claim 1, further comprising a plurality of backup network connection lines, wherein the setup module switches the primary network connection line and/or backup network connection lines orderly based on a preset backup network connection line setup specification.

6. The network backup system of claim 5, wherein the preset backup network connection line setup specification is defined based on amount of flow and/or size of bandwidth of the backup network connection lines.

7. The network backup system of claim 1, further comprising a plurality of router devices separately connected to the corresponding primary network connection line and backup network connection line.

8. The network backup system of claim 7, wherein the router devices are modems.

9. The network backup system of claim 7, wherein one end of the router device is for connecting to a second network device while another end of the router device is connected to the computer device.

10. The network backup system of claim 9, wherein the second network system is Internet, intranet, extranet, local area network (LAN), wide area network (WAN), or virtual private network (VPN).

11. The network backup system of claim 9, wherein the second network system is a wired and/or wireless network system.

12. The network backup system of claim 1, wherein the primary network connection line and/or backup network connection line are ADSL, SDSL, HDSL2, and/or G.SHDSL architectures.

13. The network backup system of claim 1, wherein the primary network connection line and/or backup network connection line are FTTB (Fiber To The Building) architecture.

14. The network backup system of claim 1, further comprising a recording module that records operation flows of the setup module and the detection module.

15. A network backup method, which is applicable to a computer device connected to a network system via a primary network connection line and at least a backup network connection line, the network backup method comprising:
(1) initializing the computer device, thereby enabling the computer device to connect to the network system via the primary network connection line; and
(2) detecting whether the primary network connection line is operating normally, and keeping the computer device to be connected to the network system via the primary network connection line if the primary network connection line is detected to be operating normally, or, commanding the computer device to switch connection to the backup network connection line, thereby connecting the computer device to the network system via the backup network connection line.

16. The network backup method of claim 15, further comprising a step (3) of: when the computer device is switching connection to the backup network connection line, keeping detecting whether the primary network connection line is operating normally, and commanding the computer device to switch connection back to the primary network connection line if the primary network connection line is detected to be operating normally, thereby enabling the computer device to connect to the network system via the primary network connection line.

17. The network backup method of claim 15, further comprising providing a plurality of computer devices connected to the primary network connection line and/or backup network connection line via a first network system.

18. The network backup method of claim 17, wherein the first network system is Internet, intranet, extranet, local area network (LAN), wide area network (WAN), or virtual private network (VPN).

19. The network backup method of claim 17, wherein the first network system is a wired and/or wireless network system.

20. The network backup method of claim 15, further comprising providing a plurality of backup network connection lines, allowing step (2) to further comprise switching the primary network connection line and/or backup network connection line orderly based on a preset backup network connection line setup specification.

21. The network backup method of claim 20, wherein the preset backup network connection line setup specification is defined based on amount of flow and/or size of bandwidth of the backup network connection lines.

22. The network backup method of claim 15, wherein the computer devices are separately connected to the corresponding primary network connection line and backup network connection lines via a plurality of router devices.

23. The network backup method of claim 22, wherein the router devices are modems.

24. The network backup method of claim 22, wherein one end of the modem is for connecting to a second network system while another end of the modem is connected to the computer device.

25. The network backup method of claim 24, wherein the second network system is Internet, intranet, extranet, local area network, wide area network, or virtual private network.

26. The network backup method of claim 24, wherein the second network system is a wired and/or wireless network system.

27. The network backup method of claim 15, wherein the primary network connection line and/or backup network connection line are ADSL, SDSL, HDSL2, and/or G.SHDSL architectures.

28. The network backup method of claim 15, wherein the primary network connection line and/or backup network connection line are FTTB (Fiber To The Building) architecture.

29. The network backup method of claim 15 further comprising (4) recording operation flow of the network backup method.
